(19) United States
(12) Patent Application Publication
(10) Pub. No.: US 2007/0086922 A1
(43) Pub. Date: Apr. 19, 2007

(54) Compact dispenser

(75) Inventors: Per Andersson, Uppsala (SE); Gerald Jesson, Enkoping (SE)

Correspondence Address: BIRCH STEWART KOLASCH & BIRCH, PO BOX 747, FALLS CHURCH, VA, 22040-0747, US

(73) Assignee: Gyros AB, Uppsala (SE)

(21) Appl. No.: 10/570,491

(22) PCT Filed: Oct. 4, 2004
(86) PCT No.: PCT/SE04/01423

§ 371 Date: Dec. 11, 2006

(30) Foreign Application Priority Data
Oct. 4, 2003 (SE) 0302649-9

(51) Int. Cl. B01L 3/02

(52) U.S. Cl. 422/100

(57) ABSTRACT

A flow through dispenser for the drop-wise dispensation of liquid which arrangement comprises: a housing (104) comprising: (i) a flow through microconduit (105) with an upstream end (106) and a downstream end (outlet) (107); and (ii) a dispenser orifice (108) between these two ends, and an inlet tube (110) which is attached to the upstream end (106) and provides an inlet (111) that can be connected to a liquid storage (112) for liquid (113) that is to be transported in flow through microconduit (105) and inlet tube (110) and/or dispensed through the orifice (108). The inner volume between the inlet and the downstream end is is ≦10 μl. An instrument set-up for drop-wise dispensation of liquid to target areas of a microdevice. The characteristic feature comprises: a) a flow through drop dispenser (202) comprising: one or more flow through paths (220) which each has an outlet (221), an inlet (222), and a dispenser orifice (208); and b) a generator for liquid transport (217) by aspirating or pushing liquid through said paths (220) from the inlet(s) (211) to the outlet(s) (221), pushing being accomplished by using over pressure of gas upstream the inlet end (211).

### TECHNICAL FIELD

The present invention relates to novel methods and dispenser arrangements, dispenser systems and dispenser set ups that provide an improved interface between macro-world storage of liquids and microdevices. The invention enables reliable and reproducible dispensation of defined liquid aliquots to predetermined target areas (TAs) of a microdevice.

The microdevice is typically in the form of a disc with a number of target areas in the same side of the disc. Microdevices typically permit parallel and/or serial processing of different or identical liquid aliquots in order to accomplish predetermined synthetic, preparative, analytical etc protocols within natural sciences, primarily biological and/or chemical sciences such as life science. The preferred microdevices are called microfluidic devices and provide enclosed microchannels for the transportation of the liquid aliquots. The devices and the process protocols are in the microformat by which is meant that the processed liquids are in the μ-range (≦5,000 μl, such as ≦1,000 μl or ≦100 μl or ≦10 μl), typically in the nl-range (≦5,000 nl, nl-format) including also the picolitre-range (≦5,000 pl, pl-format). The nl-format includes that at least one of the processed liquid aliquots has a volume ≦5,000 nl, such as ≦1,000 nl or ≦500 nl or ≦100 nl. Dispensation is drop-wise with drops that typically have volumes in the nl-range, preferably within the pl-range.

### TECHNICAL BACKGROUND AND PROBLEMS

During the last decades much attention has focused on the miniaturization of the protocols mentioned above. The advantages of miniaturization have been obvious and include possibilities to a) design devices in which the protocol can be carried out with a high degree of parallelism, b) provide compact arrangements and instrument set-ups, c) reduce the amount of reagents and samples needed, d) speed up the times needed per run of a protocol, e) increase the productivity with respect to number of runs per time unit, f) etc.

Miniaturization has encountered problems with interfacing individual microdevices with macro-world storages of liquid e.g. liquids containing analytes, reagents, washing liquids, buffers etc. It will be important to i) reduce the carry-over between different solutions that are dispensed, ii) reduce the amount of liquid actually needed for the transfer of a minute volume, iii) permit transfer of the same liquid and/or different liquids from a macroworld storage to a predetermined ordered microarray containing a multiplicity of target areas of a microdevice at a high rate and with a high accuracy, iv) reduce the effects of evaporation during dispensation, v) etc. These problems in particular apply if the volumes to be transferred are in the nl-range

Contact-free transfer utilizing traditional ink-jet technology has been promising. See the background technology given in WO 03035538 (Gyros AB, Andersson et al). Rapid transfer has been demonstrated for a single liquid (P. Cooley et al., “Application of Ink-Jet Printing technology to BioMEMS and microfluidic Systems”, in Proceedings SPIE Microfluidics and BioMems, October 2001).

Some years ago a versatile flow through microdispenser arrangement for microdevices was presented which comprised a housing with one or more flow through microconduits that via tubes are connected to liquid reservoirs and waste reservoirs to permit transportation of liquid through the arrangement. Each flow through microconduit has a dispenser orifice through which the liquid aliquots are drop-wisely dispensed to target areas that may be present on a microdevice. Pressure pulse actuating means is/are acting on the walls of the flow through microconduits in order to force droplets through the orifices. See further:

a) U.S. Pat. No. 6,192,768, Gyros AB and Laurell et al., “Flow-through sampling cell and use thereof”;

b) Laurell et al., “Design and development of a silicon microfabricated flow-through dispenser for on-line picolitre sample handling”, J. Micromech. Microeng. 9 (1999) 369-376;

c) Thornell et al., “Desk top microfabrication—Initial experiments with a piezoceramic”, 9 (199) 434-437;

d) WO 0130500, Gyros AB and Tormod et al., “Device for dispensing droplets”;

e) Stjernström et al., “A multi-nozzle piezoelectric microdispenser for improving the dynamic volumetric range of droplets” in Proceedings of μ-TAS 2000 Symposium 14-18 May, 2000, Enschede, the Netherlands, Eds. van den Berg et al., Kluwer Academic Publisher);

f) Ekstrand et al., “Microfluidics in a rotating CD, Proc. Micro Total Analysis Systems”, Proceedings of μ-TAS 2000, symposium 14-18 May, 2000, Enschede, the Netherlands, Eds. Van den Berg et al, Kluwer Academic Publisher, (2000) pp 91-;

g) Jesson et al., “Multiple separations at manolitre scale using gradient elution”, Proceedings of μ-TAS 2000, symposium Oct. 21-25, 2001, Monterey, USA, Eds. Ramsey and van der Berg (2001) Kluwer Academic Publisher;

h) WO 02100558, Gyros AB, Laurell et al., “Compound dispensing”; and

i) WO 03035538, Gyros AB, Andersson et al., “A method and instrumentation for the microdispensation of droplets”.

Reference (i) suggests various orientations of dispenser orifices and target areas relative to each other.

In spite of these recent progresses there still remains a large need to improve liquid transfer within the field of the present invention.

Aspirating of the liquid to be dispensed in this kind flow through dispensers runs a significant risk of introducing air through the dispenser orifice. This will be disastrous for a successful dispensing and may also be the reason why aspirating to our knowledge so far has not been used in this context.

### OBJECTS OF THE INVENTION

The objects of the invention are to provide dispenser arrangements, dispenser instrument set-up, dispensing methods etc that provide improvements regarding the problems and/or advantages discussed herein.

### DRAWINGS

FIG. 1 illustrates the instrument set-up and the dispenser arrangement of the invention used in the experimental part.

FIG. 2 illustrates a variant of the instrument set-up of FIG. 1. The priming arrangement and waste arrangements differ between the variants.

FIG. 3 illustrates another variant of the set-up of FIG. 1, which presents a third variant of priming and waste arrangements.

FIG. 4 illustrates still another variant, which presents a fourth variant of priming and waste arrangements.

FIG. 5 illustrates the microchannel structures of the microdevice that has been used in the experimental part. The device is circular and has a size comparable to the CD-format.

The first digit in a reference number refers to the number of the drawing. The last two digits refer to a particular feature and are typically the same for corresponding features in different drawings.

### THE INVENTION

The present inventors have recognized a number of different principles that when applied, either alone or in combination, to flow through dispensation systems will assist in reducing the problems and enhancing the advantages discussed above. These principles relate to:

a) Making the internal volume between a dispenser orifice and a storage for liquid as small as possible.

b) Dispensing against gravity, i.e. upwards.

c) Collecting the liquids to be dispensed from an essentially planar array of reservoirs containing different or identical liquids, for instance parallel collecting from selected reservoirs.

d) Parallel dispensing from an array of dispenser orifices arranged for transfer of liquid to an array of target areas on a microdevice.

e) Aspiration of a liquid through a dispenser arrangement before the liquid is dispensed through a dispenser orifice of the arrangement to a microdevice.

f) Pushing liquids to be dispensed by the use of over-pressure air or other gases through a dispenser arrangement before the liquid is dispensed through a dispenser orifice to a microdevice.

g) Proper capability of moving the dispenser arrangement, microdevice and/or reservoirs for liquids in relation to each other.

h) etc.

The volumes (aliquots) of the liquids to be collected and dispensed may differ between reservoirs and between target areas, respectively. Volumes are in the μl-range as defined elsewhere in this text, with preference for the nl-range.

Application of (c) plus (d) to dispenser arrangements, set-ups and/or systems according to the invention solves problems associated with transformation of an array of liquid reservoirs in the macroformat, e.g. a microtitre plate, to the much smaller format represented by target areas on a microdevice.

Expressions saying that tubes, conduits, channels, reservoirs, wells, orifices etc are connected to or communicate with each other shall mean that liquid is intended to be transported between them if not otherwise is apparent from the context (fluidly connected, in fluid communication etc).

### Dispenser Arrangement (First Aspect)

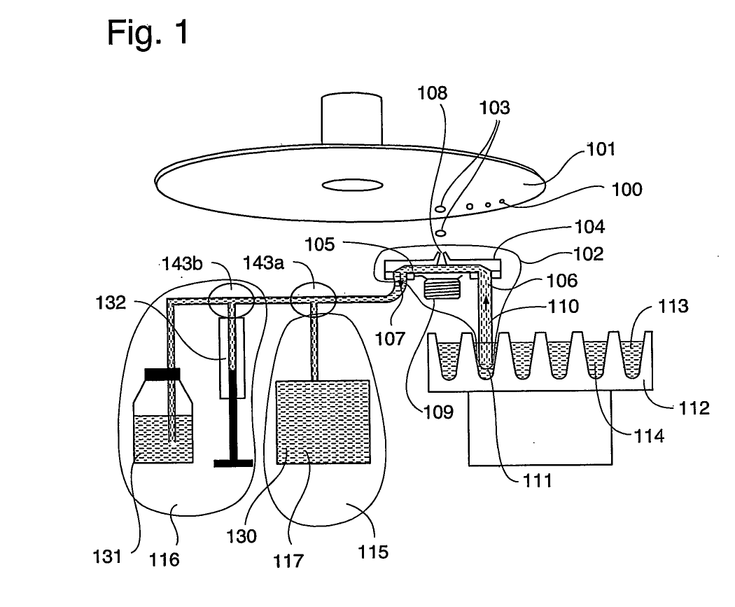

This aspect will be described based on FIG. 1. The primary goal is to reduce the internal volume of a dispenser arrangement and/or to facilitate transformation of the geometric arrangement of a number of liquid samples to the geometric arrangement of the target areas (100) of a microdevice (101). The aspect is a flow through dispenser arrangement (102) for drop-wise dispensation (103) of liquid and comprises:

a) a housing (104) that comprises (i) a flow through microconduit (105) with an upstream end (106) and a downstream end (outlet) (107), and (ii) a dispenser orifice (108) between these two ends (106 and 107),

b) pressure actuating means (109) associated with said housing (104) for dispensing drops (103) of liquid through the dispenser orifice (108), and

c) an inlet tube (110) which is attached to the upstream end (106) and provides an inlet (inlet end) (111) that can be connected to a storage (112) for liquid (113) that is to be transported in the inlet tube (110) and flow through microconduit (105), and possibly be dispensed through the orifice (108).

If not otherwise apparent from the context “dispenser arrangement” and “housing” will also be called “dispenser” and “dispenser head”, respectively.

In one embodiment the total inner volume (Vₜₒₜ) between the inlet (111) and the downstream end (107) and/or the total inner volume (V′ₜₒₜ) between the inlet (111) and dispenser orifice (108) are ≦10 μl, such as ≦5 μl or ≦2 μl or ≦1 μl. Vₜₒₜ and/or V′ₜₒₜ typically have a cross-sectional area (perpendicular to the flow direction) ≦0.5 mm², such as ≦0.1 mm² or ≦0.05 mm² or ≦0.01 mm². The length of a flow through microconduit (105) plus the inlet tube (110) (along the flow direction) is typically ≧5 mm, such as ≧10 mm, and/or ≦200 mm, such as ≦100 mm or ≦50 mm or ≦25 mm.

Each flow through microconduit (105) may comprise one, two or more dispenser orifices (108). If there are two or more dispenser orifices (108) in a flow through microconduit (105), the inner volume V′ₜₒₜ is calculated from the most upstream of them.

The inner volume (V_{cond}) of the flow through microconduit (105) is typically ≦5 μl, such as ≦2.5 μl or ≦1 μl or ≦0.6 μl or ≦0.25 μl.

The housing (104) may comprise one, two or more flow through microconduits (105). Each flow through microconduit (105) typically has a separate inlet tube (110) with an inlet opening (111). If there are two or more flow through microconduits (105), the inlet tube (110) for at least two of them may merge in the upstream direction to a common inlet (not shown).

A flow through microconduit (105) may divide into microconduit branches within the housing (104) of the dispenser arrangement. Each daughter microconduit may have one, two or more dispenser orifices and/or a downstream end (outlet) that is separate from the downstream ends of other branches, and/or may rejoin with other branches within the housing and end in a common outlet end (not shown).

The inner volume of the inlet tube (110) (Vᵢₙₗₑₜ) is typically larger than the inner volume of the flow through microconduit to which it is connected. Typically volume values (Vᵢₙₗₑₜ) are found in the intervals <10 μl, such as <5 μl or <2 μl or <1 μl. The length of the inlet tube is typically larger than the length of the flow through microconduit. Suitable lengths are typically found in the interval ≧5 mm, such as ≧10 mm, and/or <200 mm, such as <100 mm or <50 mm or <25 mm.

The volume ratio Vₜₒₜ/V_{cond}≧V′ₜₒₜV_{cond}≧1 by definition. In preferred variants either one or both of the ratios are ≦75 or ≦50, such as ≦25 or ≦10. Vₜₒₜ, V′ₜₒₜ and V_{cond} have the same meaning as above. The length ratio Lₜₒₜ/L_{cond}≦L′ₜₒₜ/L_{cond}≧1 by definition. In preferred variants either one or both of these ratios are ≦75 or ≦50, such as ≦25 or ≦10. Lₜₒₜ is the length in the flow direction between the outlet (106) and the inlet (111), L′ₜₒₜ is the length between the dispenser orifice (108) and the inlet (111), and L_{cond} is the length of the flow through microconduit (105).

The inlet tube (110) comprises only one inlet (111) that is intended to be in fluid communication with a liquid storage (112) containing one, two or more reservoirs (114) for liquid (113), i.e the inlet tube has no branches with inlets for the introduction of liquids into the dispenser arrangement. An inlet thus typically is intended to be in direct fluid communication with a liquid reservoir (114). Alternatively, the inlet (111) may be connected to a tubing that in the upstream direction comprises a junction at which two or more flow tubes coming from separate liquid reservoirs merge. These latter liquid reservoirs may or may not be part of the liquid storage (112) (not shown).

The downstream end (107) of the flow through microconduit (105) is for fluid connection to a waste arrangement (115), possibly via tubes that provide fluid communication with arrangements that have other functions. Other arrangements are one or more other flow through dispenser arrangements, a priming arrangement (116) (see below), a generator for liquid transport (generator I) (117) etc.

The dispensation function is based on the presence of a dispensing actuator (109) that is associated with a dispensing orifice (108), for instance with the wall in close proximity of the orifice such as opposite to the orifice. The actuator typically creates pressure pulses in the liquid meaning that each pulse of sufficient amplitude and/or frequency will actuate pressure on the liquid and eject a droplet (103) through the dispenser orifice (108). In an advantageous variant, the actuator (109) comprises a piezoelectric element, magnetorestrictive element, an element sensitive to externally applied pressure pulses etc enabling well-defined dispensing pulses.

The desired size of droplets (103) is typically found in the range of 10⁻⁶-10⁰ μl, for instance ≦5×10⁻³ μl such as ≦5×10⁻⁴ μl with the lower limits being 1×10⁻⁵ or 1×10⁻⁴ μl.

The dispenser orifice (108) may have different geometric forms, for instance circular, ellipsoid, oval and have otherwise rounded forms. The orifice may comprise a collection of minor holes or pores that in turn may be rounded and/or be delineated by straight sides. In this latter case the holes or pores are typically symmetrically arranged relative to the centre of the orifice. The diameter of the orifice is typically within 10-200 μm. The orifice may be in the form of a tip. The outer rim and typically also the surface surrounding the orifice are preferably hydrophobic (non-wettable).

Pressure actuating means may be common for two or more dispensing orifices in the same flow through microconduit, in different microconduits or in different branches of the same microconduit.

Suitable flow through drop dispenser arrangements are known from the publications given above (Laurell et al., Thornell et al, Tormod, Stjernström et al., Jesson et al, Andersson et al, and Ekstrand et al).

In a preferred variant the housing (108) has two or more flow through microconduits.(105) each of which is connected to an inlet tube (110) with an inlet (11), i.e. two or more inlet tubes/inlets in one housing (104). The geometric configuration of the inlets relative to each other may be fixed or adjustable and adapted/adaptable to fit to the geometric configuration of an array of liquid reservoirs or to fit into one single common reservoir. Compare the array of reservoirs in the storage plate discussed elsewhere in this specification. The dispenser orifices typically have a geometric configuration relative to each other that fit the configuration of target areas on a microfluidic device. Each of the flow through microconduits may contain one, two or more dispenser orifices. This kind of dispenser head is extremely potent for parallel dispensation to an array of target areas from an array of liquid reservoirs having another or the same geometric configuration as the target areas, and will henceforth be called “transformation dispenser”. As indicated this kind of dispenser head can also be used for collecting liquid from a common reservoir into which two or more of the inlets can be dipped.

### Instrumentation Set-Up (Second Aspect)

The features of the first aspect are applicable also to the dispenser part of the second aspect of the invention.

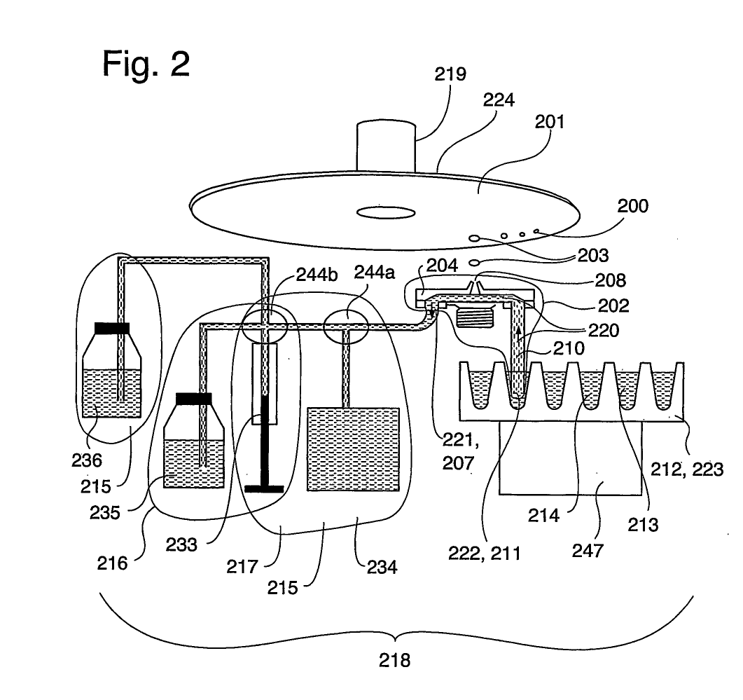

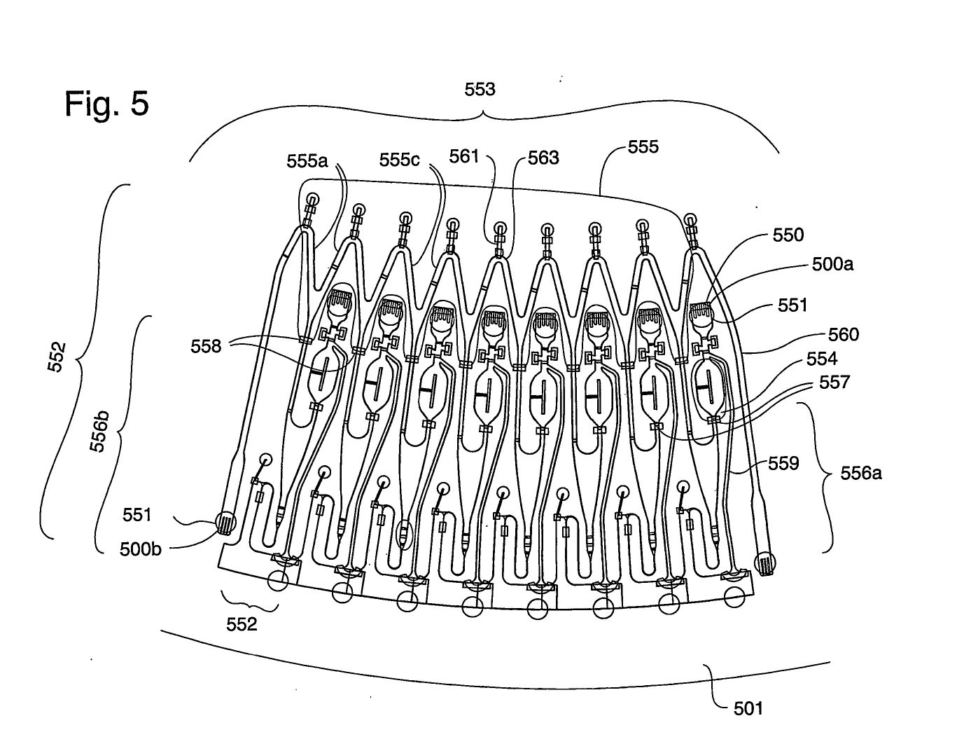

The second aspect will be described based on FIG. 2 except for the microdevice, which will be described based on FIG. 5. The second aspect aims at designing compact systems for dispensation of liquids (203) to microdevices (201) of the kind described in this specification.

The second aspect of the invention is an instrument set-up or a system (218) for the drop-wise dispensation (203) of liquid to target areas (200) that are present in the same side of a microdevice (201). The characteristic feature comprises:

a) a flow through drop dispenser arrangement (202) comprising: one or more flow through paths (220) which each has (i) an outlet (221), (ii) an inlet (222), and (iii) a dispenser orifice (208) between the outlet (221) and the inlet (222), and

b) a generator for liquid transport (transport generator I) (217) that is capable of causing transport of liquid through said flow through paths (220) in the direction from an inlet (211) to an outlet (221) by aspirating or pushing liquid.

The second aspect typically also comprises:

a) a support (224), to which the microdevice (201) is retained,

b) a waste arrangement (215), and

c) a liquid storage (212) comprising one, two or more reservoirs (214) for storing liquid (213) to be dispensed to the microdevice (201).

In the case of aspirating, transport generator I is acting via the outlet end (221) by applying suction and/or subpressure to suck/pull liquid from a liquid reservoir (214) through the flow through path (220) via the inlet (222).

In the case pushing is used, the transport generator I is acting via the inlet (222) by applying overpressure gas to the liquid to be passed through the flow through path (220), e.g. in the reservoirs (214) of the liquid storage (212).

The different parts of the second aspect are connected to each other in the following manner:

A) the outlet (221) of the dispenser arrangement (202) is capable of being fluidly connected to the waste arrangement (215),

B) the inlet (222) of the dispenser arrangement (220) is capable of being fluidly connected to one or more of the reservoirs (214) of the liquid storage (212),

C) the dispenser orifice(s) (208) and the side comprising the target areas (200) of a microdevice (201) are turned against each other, and

D) either one or both of the microdevice (201) and the dispenser orifice(s) (208) are movable relative to each other thereby enabling dispensation of liquid droplets (203) from a dispenser orifice (208) to one, two or more target areas (200).

The orthogonal distance between a dispenser orifice (208) and the side of the microdevice (201) comprising the target areas (200) is typically within the interval 1-30 mm. This distance may be fixed, or adjustable. Adjustment is preferably by moving the support (224) towards or away from the dispenser orifice (208). See for instance WO 03035538 (Gyros AB). If there are two or more dispenser orifices (208) they are preferably at the same orthogonal distance from the microdevice (201). The dispensation direction from the orifice (208) is typically orthogonal to the microdevice side that contains the target areas (200).

In certain preferred variants the openings of one or more of the reservoirs (214) of the liquid storage (212) are located on a planar side of a plate (storage plate, e.g. microtitre plate) (223). When this storage plate is placed in the instrument set-up, the side containing the openings of the reservoirs (214) is turned in a direction that is opposite to the direction of the microdevice side containing the target areas (200). The dispenser housing (204) is placed between the storage plate (223) and the microdevice (201) with the dispenser orifice (208) turned against the microdevice to provide an orthogonal dispensation direction towards the microdevice (201). See FIGS. 1-4.

In preferred variants, the target areas (200) and the microdevice (201) are horizontally oriented while the dispensation direction is vertical, typically with the target areas (200) turned downwards combined with an upward dispensation direction (203). If the liquid storage (212) in these latter variants is in the form of a plate (223) containing the reservoirs (214) in one of its sides, the opening of the reservoirs are typically turned upwards. If the openings of the reservoirs (214) are turned in other directions, e.g. up and down, they should be sealed unless they contain volumes that are sufficiently minute to be self-adhering to surfaces (i.e. inner surfaces of the reservoirs). Such volumes may be found in the interval, <30 μl, such as <15 μl or <5 μl. A leakage-proof membrane that can be penetrated by the inlet (222) of the flow through path (220) can be used for sealing the reservoirs in order to prevent evaporation and/or other losses.

The required movement of the target areas (200) and a dispenser orifice (208) relative to each other depends on the configuration of the target areas (200). Typical variants includes that the support (224) is linked to a rotor axis (219) or to an X,Y-robot (not shown) for circular or linear/lateral movements, respectively, of the target areas in front of the dispenser orifices. The circular movement caused by a rotor axis (219) can be combined with lateral movement of either the support/microdevice (224/201) and/or the dispenser orifices/dispenser (208/202) if the target areas (200) are located at different radial positions from the rotor axis (219). An alternative for an X,Y-robot to move the support would be a robot that separately could move the support/microdevice (224/201) and the dispenser/dispenser orifice (202/208).

In certain preferred variants the drop dispenser arrangement (202) is according to the various embodiments that are outlined for the first aspect of the invention. This means that the inlet (222) and the outlet (221) of each flow through path (220) are equal to an inlet (211) and an outlet (207), respectively, of the dispenser arrangement of the first aspect (as shown in FIGS. 1-4).

Support To Which A Microdevice Is Retained

The support (224) is capable of retaining a microdevice (201) during dispensation. The support also assists in individually aligning target areas (200) with dispenser orifices (208) of the dispenser arrangement (202). The term “align” in this context means that a target area (200) is in a position for receiving a droplet (203) ejected from a dispenser orifice (208), e.g. includes ejection while the target areas (200) are moving in front of a dispenser orifice (208), ejection while the target areas (200) are not moving, ejection when the dispenser orifices (208) are displaced relative to each other etc. Compare for instance WO 03035538 (Gyros AB) that deals with dispensation from orifices while the microdevice/target areas is/are spinning/rotating.

The support (224) may be in the form of a plate, holder and the like.

To accomplish alignment, the support (224) is linked to the appropriate arrangements (robotics) for moving the microdevice/target areas (201/200) as described above.

Microdevice

The microdevices that are used in the system of the invention are of the type indicated in the introductory part. FIG. 5 shows a group (553) of microchannel structures (552) in a sector of a circular microfluidic device. The structures are linked together by a common distribution manifold. See below and WO 02074438 (Gyros AB), WO 02075312 (Gyros AB) and WO 0275775 (Gyros AB). See also PCT/SE2004/000440 (Gyros AB).

A “target area” (TA) (500a,b) contemplates a discrete predetermined area for which the position co-ordinates relative to a reference point are known before dispensation. Chemical and/or physical barriers (550 and 551, respectively)) typically wholly or partly surround a target area in order to prevent undesired wetting around the target area. A chemical barrier may be in the form of hydrophobic patch (550). A physical barrier may be in the form of the inner walls (551) of a target area (500). In microfluidic devices (501), a target area (500a,b) is linked to a microchannel structure (552) in which one or more liquid aliquots are transported and processed.

The individual TAs (500a,b) typically have sizes ≦2.5×10¹ mm², such as ≦100 mm² or ≦10⁻¹ mm² or ≦10⁻² mm² or ≦10⁻³ mm². The lower limit is typically ≧10⁻⁵ mm², such as ≧10^{-4 mm}² or ≧10⁻³ mm² or ≧10⁻² mm².

The microdevice (501) is typically in the shape of a disc. Typical disc formats have an n-numbered axis of symmetry (Cₙ) perpendicular to the disc plane where n is an integer >0, such as 2, 3, 4, 5, 6 or larger. Circular forms are included (n=∞).

The microdevice (501) typically comprises one, two or more target areas (500) and/or microchannel structures (552), such as ≧10, or ≧50 or ≧100 target areas and/or microchannel structures. The TAs and microchannel structures may be arranged in subgroups (553) such that all TAs in a subgroup are at the same X- or Y-co-ordinate or radial coordinate (shown). For devices having a Cₙ-axis, the TAs of a subgroup may be at the same radial co-ordinate (radial distance) but at different angular co-ordinates. The TAs may also be arranged in other configurations, e.g. in spiral-like manner around a Cₙ-axis.

The term “microchannel structure” contemplates that the structure comprises one or more cavities/chambers and/or channels that have a cross-sectional dimension that is ≦10³ μm, preferably ≦10² μm. The volumes of cavities/chambers are typically ≦1000 nl, such as ≦500 nl or ≦100 nl or ≦50 nl or ≦25 nl. The nl-range in particular applies to microcavities that are used for detection and/or for performing various reactions, such as enzymatic and/or affinity reactions including also cell reactions and separations and enzymatic reactions with a solid phase exhibiting an affinity reactant or an enzyme reactant placed in the microcavity.

The transport of liquid within the microchannel structures (552) may be driven by various forces, for instance inertia force such as centrifugal force, electrokinetic forces, capillary forces, hydrostatic forces etc. Pumping mechanisms of various 10 kinds may be used, for instance pumps. In variants preferred by the inventors, centrifugal force and/or capillary force are utilized for transporting liquids from an inlet port/target area (500a,b) into different individual fluidic functions of a microchannel structure (552).

The disc (501) may be made from different materials, such as plastic material, glass, silicone etc. Polysilicone is included in plastic material. From the manufacturing point of view plastic material is many times preferred because this kind of material are normally cheap and mass production can easily be done, for instance by replication. Typical examples of replication techniques are embossing, moulding etc. See for instance WO 9116966 (Pharmacia Biotech AB, Ohman & Ekström). Replication processes typically result in open microchannel structures that are exposed in a substrate which subsequently is covered by a lid or top substrate, for instance according to the procedures presented in WO 0154810 (Gyros AB, Derand et al) or by methods described in publications cited therein. The proper hydrophilic/hydrophobic balance of the interior surfaces of the microchannel structures may be obtained according to principles outlined in WO 0056808 (Gyros AB, Larsson et al) and WO 0147637 (Gyros AB, Derand et al). In other words, interior surfaces of the microchannel structures are typically hydrophilic by which is meant that the water contact angle of the surfaces deriving from the replicated part and/or a cover is at least ≦90°. Preferably hydrophilic surfaces have water contact angles that are ≦50°, such as ≦40° or ≦30° or ≦20°. The basic criterion is that hydrophilicity should be sufficient to allow for self-suction of aqueous liquids into the microchannel structures, in particular from the inlet port. These ranges also apply to the hydrophilicity of target areas. The microchannel structures may also have inner surfaces that are hydrophobic, for instance at valve functions, anti-wicking functions and pure venting functions. See below. Surfaces that are not hydrophilic are hydrophobic, i.e. have a water contact angle ≧90°.

In a preferred microfluidic device (501) a target area/inlet port (500a,b) is fluidly connected to a microcavity (554,555), which is capable of retaining and/or metering a liquid volume in the nl-range. In this context nl-range means <5,000 nl including the pl-range (<5,000 pl) and typically is 5-1,000 nl, such as >50 nl and/or <750 nl.

This kind of microcavity may be a metering microcavity (554,555) and is typically located in direct fluid communication and/or close to an inlet port (500a,b) and used for metering a liquid volume that is to be transported further downstream (556a,b) into the microchannel structure(s) that is(are) fluidly connected to the microcavity (554,555) and inlet port (500). A typical metering microcavity is in its downstream end delineated by a valve function (557,558) and in its upstream end has some kind of overflow system or overflow microconduit (559,560). The microcavity may thus be
A) a single volume-metering microcavity (554) in the case the inlet port (500a) and the metering microcavity (554) are only connected to one microchannel structure (552) or
B) a distribution manifold in the case the inlet port (500b) and the metering microcavity (555) are fluidly connected to two or more microchannel structures (552).

If the microcavity (555) corresponds to a distribution manifold it will comprise one metering submicrocavity (555a,b,c . . . ) per microchannel structure (552) associated with the inlet port/target area (500b). At each connection between a submicrocavity (555a,b,c . . . ) and downstream parts (556a,b) of a microchannel structure (552) there is a valve function (558). The distribution manifold/microcavity (555) typically comprises a fluidic function between two neighbouring submicrovacities (555a,b,c . . . ) that will assist in a reliable and reproducible partition of the metered volume into the different microchannel structures, e.g. hydrophobic patches (shown), vents to ambient atmosphere (561), upward bents (562) etc.

The wettability of this kind of inlet arrangement should be sufficient to fill a metering microcavity (554,555) with liquid by capillarity or self-suction once liquid has been dispensed to the corresponding inlet port (500a,b).

Preferred valves to be used at one or more of the positions within a microfluidic device as discussed herein are non-closing and are illustrated with passive valves or capillary valves in which the valving function often is based on a change in
a cross-sectional dimension of a microconduit (change in geometric surface characteristics) and/or
chemical surface characteristics (e.g. a boundary between a hydrophilic (wettable) and a hydrophobic (non-wettable) surface) (557,558).

At least with respect to chemical surface characteristics the change is local meaning that the interior surface upstream and downstream the valve function is wettable. The difference in wettability across a boundary of a passive valve used in the invention is typically ≧30°, such as ≧30° or ≧40°.

Suitable metering microcavities and non-closing valves are well-known in the literature. See for instance WO 0274438 (Gyros AB), WO 0308198 (Gyros AB) etc. See also the microfluidic device used in the experimental part.

Waste Arrangement, Generator For Liquid Transport (Transport Generator I), And Priming Arrangement

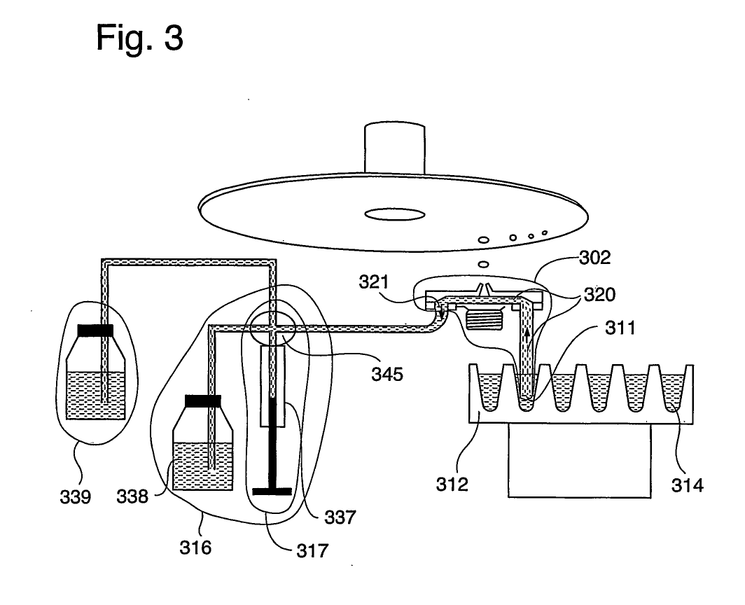

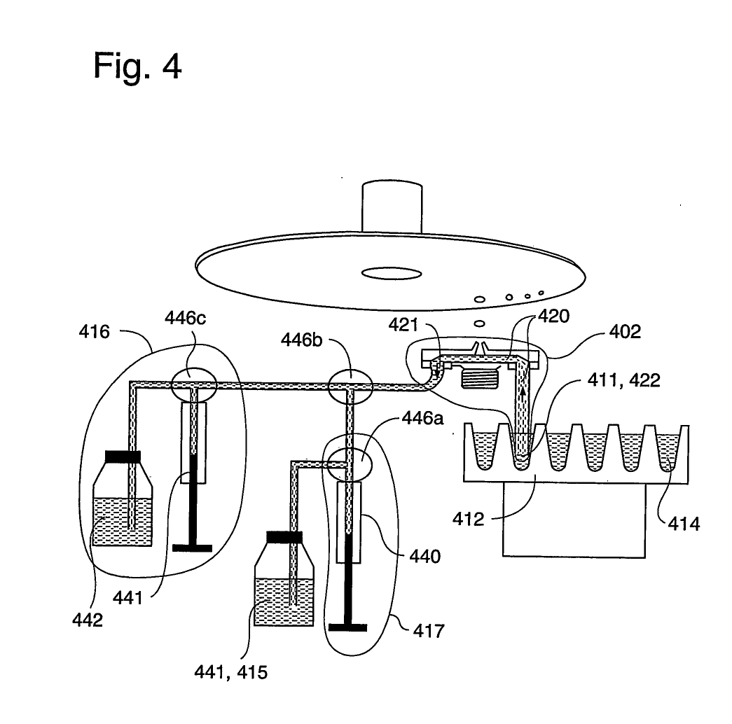

Variants of these subparts of the set-up of the invention are illustrated in FIGS. 1-4. The term “vacuum system” includes appropriate “sub-pressure systems”.
FIG. 1: The generator for liquid transport (117) in this variant is a vacuum system (130) connected to the outlet (107) of the dispenser arrangement (102). The vacuum system is used for aspirating liquid through the dispenser arrangement (via the inlet (211) and for emptying the dispenser arrangement after dispensation. The vacuum system (130) may be part of the waste arrangement (115). The priming arrangement (116) is represented by a reservoir (131) for priming liquid and a syringe pump (132) used for introducing priming liquid via the outlet (107) of the dispenser arrangement (102). This variant illustrates that separate liquid moving systems can be used for moving priming liquid and liquids that are to be aspirated through the inlet (211).
FIG. 2: The generator for liquid transport (217) comprises in this variant a syringe pump (233) for aspirating liquid via the inlet (211,222) and a vacuum system (234) for subsequent emptying of the dispenser arrangement. (202) The priming arrangement (216) comprises a separate reservoir (235) for priming liquid and a syringe pump (233) for introducing priming liquid via the outlet (207,221) of the dispenser arrangement. The waste arrangement (215) comprises a separate reservoir for waste (236) and possibly also reservoirs for waste within the vacuum system (234).
FIG. 3: The generator for liquid transport (317) comprises in this variant a syringe pump (337) for aspirating liquid via the inlet (311,322) and for subsequent emptying of the dispenser arrangement (302). The priming arrangement (316) comprises the same syringe pump (337) as the generator for liquid transport and a separate reservoir (338) for priming liquid. The waste arrangement (315) comprises a separate waste reservoir (339) linked to the syringe pump (337).
FIG. 4: The generator for liquid transport (417) comprises in this variant a separate syringe pump (440) for aspirating liquid through the dispenser arrangement (402) via the inlet (411,422). Emptying of the dispenser arrangement may be accomplished by the same syringe pump (440) or by a separate vacuum system (not shown) (part of generator for liquid transport). The syringe pump (440) is emptied into a separate waste reservoir (441) that is part of the waste arrangement (415). The priming arrangement (416) comprises a separate syringe pump (441) and a separate reservoir (442) for priming liquid.

Appropriate valves are present at junctions in the tubings used for linking various parts of the waste arrangement, generator for liquid transport and priming arrangement to each other. See 143a,b and 244a,b and 345, and 446a,b,c.

Waste Arrangement

The waste arrangement is fluidly connected to the outlet (107,221,321,421) of the dispenser arrangement and typically comprises one or more reservoirs for waste liquids. These reservoirs may be common for two or more, preferably all of the outlets in the case the dispenser arrangements comprises a plurality of outlets.

Waste liquid typically comprises liquids that have been allowed to enter the flow through path(s) but haven't been dispensed through the dispenser orifice(s) (reagents, sample possibly containing analyte, diluents, washing liquids, etc). The waste liquid may also comprise used priming liquids. Washing liquids in this context means liquids used to clean the flow through path(s) (105+110,220,320,420) and/or liquids used to wash the microchannel structures (552) of the microdevice (201).

The waste arrangement comprises also suitable valves and tubings that are necessary to connect the waste reservoirs and/or the outlet(s) with each other. See above 143a,b and 244a,b and 345, and 446a,b,c.

The positions of the reservoirs of the waste arrangement are typically fixed during dispensation. Valves and tubings may permit that waste liquid is collected in predetermined waste reservoirs.

Generators For Liquid Transport (Transport Generator I, II, IlI Etc)

Liquid transport generator I is primarily for transporting samples, reagents, washing liquids and other liquids used in an intended process protocol. The generator causes transport from a reservoir (114,214,314,414) of the liquid storage (112,212,312,412) to the waste arrangement and is based on aspirating or pushing liquid from a reservoir (114,214,314,414) of the liquid storage through the inlet and further downstream to a waste reservoir of the waste arrangement.

Aspirating in this context means that the liquid flow is driven by a pressure differential through the flow through paths. The differential provides reduced pressure at the outlet (107,221,321,421) of a flow through path (105+110,220,320,420) and/or in other appropriate positions downstream the outlet (107,221,321,421), e.g. in the waste reservoir(s).

Aspirating is typically accomplished by a pumping mechanism that makes use of a pump selected amongst piston-driven pumps (e.g. syringe pumps), peristaltic pumps, electroosmotically driven pumps, membrane pumps, hydrostatic pumps, vacuum pumps (as part of a vacuum system linked to the waste arrangement) etc. The pumps may be with or without mechanical parts.

The reduced pressure may in principle be created at any position downstream the outlet (107,221,321,421) as long as there is no disturbing leakage upstream the application of sub-pressure. Sub-pressure is typically initiated within a waste arrangement.

Pushing contemplates that the liquid transport is driven by a pressure differential that provides over-pressure at the inlet (111,222,322,422) of a flow through path (105+110,220,320,420).

Pushing may be accomplished by having gas of elevated pressure acting on the surface of the liquid in the reservoirs (114,214,314,414) of the liquid storage (over pressure, typical relative to atmospheric pressure). In the case the liquid storage is in the form of a plate with open reservoirs the whole plate is placed in a space permitting elevated gas pressure in contact with the liquid surface in each reservoir, e.g. in a pressurized box.

The set up may also comprise a second liquid transport generator II for priming liquid and/or a third transport generator III for washing liquid. Each of these transport generators may fully or partly be used also as one or more of the other transport generators even if they are named differently.

Priming Arrangement (116,216,316,416)

Priming typically means that an empty part (priming section) of the flow through part is filled with a liquid (priming liquid, sacrificing liquid) before the liquid to be dispensed to a target area is introduced. The priming section preferably extends from the inlet (111,222,322,422) and downstream to the dispenser orifice (108,208,308,408) which also is part of the section. In the case the flow through path comprises several dispenser orifices the priming section extends to cover all of them.

The present inventors have realized that priming of the flow through path (105+110,220,320,420) with liquid is highly recommendable, if aspiration is to be used for filling up the flow through path with liquid from a liquid storage (112,212,312,314) fluidly connected to the inlet (111,222,322,422). Without priming, air will be sucked into the flow through path via the dispenser orifice (108,208,308,408) instead of liquid via the inlet (111,222,322,422). The incorporation of a priming arrangement facilitates the design of efficient dispensing set-ups and systems, and also leads to reduction of the liquid volumes required for dispensation.

The priming liquid typically should contain no reagents/reactants that participate in the reactions used in the protocol to be performed within the microdevice (201). In preferred variants the priming liquid may be the same or similar to a washing or cleaning liquid. This does not exclude that in some variants the priming liquid may contain reagents/reactants, sample possibly containing an analyte etc, in particular if liquids containing these substances are cheap and/or easily accessible.

The priming arrangement typically comprises two parts:

a) a reservoir for priming liquid, and

b) a generator for transport of priming liquid (transport generator II) for driving a priming liquid to the priming section.

If there are two or more flow through paths in the set up, e.g. in the same dispenser arrangement, the same priming arrangement preferably is used for all of them.

The reservoir for priming liquid (131,235,338,442) may be fluidly linked to

(i) the outlet(s) (107,221,321,421) of the flow through path(s), e.g. via suitable tubings, or

(ii) the inlet (111,222,322,422) of a flow through path, e.g. being part of the liquid storage.

Alternative i) is preferred.

The generator for transport of priming liquid (generator II) is typically pressure driven and comprises a pumping mechanism that creates a suitable pressure differential along the flow through path (105+110,220,320,420) for driving the priming liquid to the priming section. In some variants the reservoir (131,235,338,442) for priming liquid in alternative (i) is positioned downstream the outlet (107,221,321,421) and the pumping mechanism creates an elevated pressure on the priming liquid that is pushed through the outlet (backwards) (107,221,321,421) to fill up the flow through path (105+110,220,320,420) up to the inlet (111,222,322,422) (including the priming section). In other variants of alternative (i), reduced pressure is created upstream the inlet end (111,222,322,422) and priming liquid stored downstream the outlet (107,221,321,421) is aspirated into the priming section. In this latter case it is advantageous to have a closable venting function (not shown) associated with the dispenser orifice (108,208,308,408) for precluding air from entering the priming section during priming.

Alternative ii) may utilize a pumping mechanism associated with either a position downstream the outlet or a position upstream the inlet (aspirating and pushing, respectively).

The pumping mechanism used in the priming arrangement may the same as outlined for transport generator I.

Liquid Storage

The liquid storage (112,212,312,412) may contain one, two or more reservoirs (114,214,314,414) for storing liquids (113,213,313,413) such as wash liquids for cleaning a flow through path, liquids to be dispensed through a dispenser orifice (108,208,308,408) of the set-up, etc. Depending on the priming system that possibly is used, the liquid storage may also comprise a reservoir for priming liquid. See above. Each of the reservoirs is capable of being fluidly connected to an inlet (111,222,322,422) of the dispenser arrangement (102,202,302,402). In other words the inlet(s) and the liquid storage are adjustable relative to each other such that liquid from one, two or more, preferably any, of the reservoirs (114,214,314,414) of the storage arrangement is able to enter a flow through path via an inlet.

There are two main alternatives of liquid storage.

The alternative illustrated in FIGS. 1-4 is preferred (first alternative) and will now be detailed with reference to FIG. 2. The reservoirs (214), e.g. wells, are present in one side of a plate (storage plate) (223), e.g. a microtitre plate (in fact have openings in one side of the storage plate). The inlet(s)/inlet tube(s) (222/210) of the dispenser is(are) directed against this side. This means that fluid communication can be established between an inlet (222) and individual liquid storage reservoirs (214), if the storage plate (223) and/or the inlet (211) can be moved relative to each other in an X,Y-plane and in the Z-direction (X,Y-plane parallel to the storage plate (223). This movement may e.g. be accomplished by keeping the inlet(s) (211) of the dispenser arrangement (202) at a fixed position and

a) manoeuvring the storage plate (223) in the X-, Y-, and Z-directions, or

b) rotating the plate (223) around an axis that is orthogonal to X,Y-plane combined with lateral and orthogonal movement (Z-movement) of the storage plate (223).

The side of the storage plate (223) containing the openings of the reservoirs (214) is preferably oriented horizontally with the Z-direction vertical, preferably upwards.

Manoeuvring of the storage plate is typically carried out with the appropriate robotics as indicated on FIG. 2 (247)

Movement of the dispenser head (204) and the inlet(s) (222) of the dispenser arrangement (202) is less preferred because this would interfere with and complicate the targeting with the microdevice (the TAs) during dispensation.

Advantages can be obtained in the case a storage plate (223) is combined with the transformation dispenser discussed in the context of the first aspect and selected such that an array of inlets (arrayᵢₙₗₑₜ) (222) defined by the inlets of the dispenser (102) matches an array of reservoirs (arrayᵣₑₛₑᵣᵥₒᵢᵣ) defined by at least some of the reservoirs (214) of the storage plate (223) such that the inlets of arrayᵢₙₗₑₜ can be fluidly connected in parallel the opening(s) of to one, two or more reservoirs of arrayᵣₑₛₑᵣᵥₒᵢᵣ. Each of the inlets of arrayᵢₙₗₑₜ may for instance be connected to a reservoir that no other inlet of arrayᵢₙₗₑₜ is connected to, or all of the inlets of arrayᵢₙₗₑₜ may be connected to one common reservoir.

The storage plate/dispenser configuration discussed in the preceding paragraph is preferably combined with a microdevice that has an array of target areas (array_{TA}) that matches an array of dispenser orifices (array_{orifices}) defined by the dispenser arrangement used, such that dispensation can take place in parallel from each of the dispenser orifices of array_{orifices} to each of the target areas of the array_{TA} on the microdevice. In the case array_{TA} comprises only a part (subarray) of the target areas of the microdevice, the complete dispensation process will encompass repetitive array_{TA} or subarray dispensation, in particular if the configuration of target areas within array_{TA} is occurring repetitively on the microdevice.

The volume of liquid (213) retained in each reservoir (214) in the liquid storage (212) is typically in the μl-range as defined in the introductory part, e.g. ≦5,000 μl, such as ≦1,000 μl or ≦500 μl or ≦100 μl. In certain variants the volume may be small enough for surface forces between the liquid and the inner surface of a reservoir to override gravity. This means that the storage plate (223) can be kept at any direction relative to gravity. A sealing membrane to keep the liquid in place is not required. For variants in which surface forces override gravity the reservoirs may be in the form of holes passing through the storage plate.

A second alternative for liquid storage comprises tubings comprising branchings and/or valves to connect an inlet (222) of a flow through path (220) of a dispenser arrangement (202) with anyone of the different reservoirs (214) of the liquid storage (212). In this variant there is no need for moving a storage plate and reservoirs since merely opening and closing of valves accomplish fluid connection/disconnection to the appropriate inlet(s).

Washing Arrangement

The washing arrangement is for cleaning the inlet(s) (222) and/or the interior of the flow through path(s) (220) including the dispenser orifice(s) (208). The washing arrangement comprises one or more reservoirs for washing liquid. These reservoirs may be part of the liquid storage (212) or may be separate.

The reservoir for washing liquid intended to pass through flow through path(s) is typically connected to a flow through path (220) either upstream the inlet(s) (222) or downstream the outlet(s) (222).

Washing may include cleaning the outside of the inlet(s) by dipping an inlet into a washing liquid or by flushing the tip with the washing liquid. The reservoir for washing liquid may according to both alternatives be part of the liquid storage or be separate, in particular with respect to flushing liquids.

The transport generator for washing liquid (generator II) may be separate from or be the same as transport generators I and/or II. The mechanisms for liquid transport may be as discussed for these other two generators for liquid transport.

Miscellaneous

In preferred variants the instrument set-up also includes suitable software and computers that can be programmed for dispensation according to predetermined protocols and microdevices.

### Instrument Set-Up Enabling Array Transformation Dispensation And/Or Dispensation Against Gravity (Third Aspect)

The instrument set-up of this aspect utilizes drop-wise dispensation of liquid to the same kind of microdevices (201) as in the second aspect, with preference for microfluidic devices. This set-up is characterized in comprising:

a) a drop dispenser arrangement (202) that has (i) one or more inlets (222) connected to a liquid storage plate (223), (ii) one or more dispenser orifice(s) (208) for dispensing drops (203) of liquid to the target areas (200), and (iii) a microconduit (part of 220) fluidly connecting an inlet (222) with the dispenser orifice (208),

b) the microdevice (201), and

c) the storage plate (223) that comprises liquid reservoirs (214) in one of its sides,

The microconduit in (iii) goes from an inlet (222) an at least down to the dispenser orifice (208). The side of the microdevice (201) containing the target areas (200) is turned against the dispenser orifice (208).

The dispenser arrangement is in a preferred variant the transformation dispenser arrangement discussed in the context of the first aspect.

The inlet(s) (222) and the storage plate (223) are movable relative to each other such that fluid communication can be established between one, two or more of the inlets (222) and at least one of the liquid reservoirs (214) per inlet at a time. Typically contact is established in parallel for two, three or more inlets. See the other aspects.

The dispensation direction from the orifice is typically orthogonal to the side of the microdevice comprising the target areas.

In preferred variants the side of the microdevice (201) comprising the target areas (200) and the side of the storage plate (223) comprising the openings of the liquid reservoirs (214) are turned in opposite directions. The dispenser orifice (208) is between these sides and turned against the microdevice (against the side comprising the target areas).

In certain preferred variants the dispensation direction is at least partially against gravity (=upward), e.g. the side comprising the target areas of the microdevice is turned downwards and is horizontal or angled against the horizontal plane. The dispenser orifice is directed upwards, preferably vertically.

Dispenser arrangements based on the flow through principle with a dispenser orifice (208) between the ends (222,221) of a liquid through flow path (220) are preferred. See the publications discussed as back-ground technology above and the variants given in the context of the first and second aspect of the invention.

Also other kinds of drop dispensers can be used in this aspect, for instance drop dispensers in which the microconduit going from the inlet (211) to the dispenser orifice (208) is not part of flow through path (220) having an outlet (222) for excess of liquid that is separate from the dispenser orifice (208).

Typically such other drop dispensers comprise a liquid transport channel which
a) starts with an inlet to be fluidly connected to a liquid reservoir,
b) ends in a dispenser orifice, and
c) has a dispensing actuator associated with the channel in an upstream position relative to the orifice.
   The actuator may be ring-formed and fully or partially embracing the liquid flow passing through the channel. In the case electrical pulses are used for droplet formation the ring may comprise a piezoelectric material. This kind of drop dispensers is available from Cartesian (England) and can be used in the third aspect of the present invention if properly modified. Other candidate dispensers are based on the bubble-jet principle developed for example by Olivetti (Italy), or based on other pieozoelectric transducers or speakers available from MicroFab (USA) and/or based on continuous mode ink-jet working according to Rayleigh break up principle and/or where droplets are directed under a deflection field.

Recently it has been suggested that dispensation can be accomplished from capillary tubes dipped into a liquid reservoirs and applying suitable energy to the tube walls. It can be envisaged that this technique can be powerful in the third aspect of the present invention. A multiplicity of this kind of capillaries or a single one of the capillaries could be incorporated in a suitable housing (dispenser head) and function as the dispenser head in the first and second aspect of the invention, for instance as a transformation dispenser, except that the principle of aspiration wouldn't be applicable.

Compared to flow through dispensers, the dispenser variants described in the preceding three paragraphs are likely to require more complex design and/or complicated procedures for replacing the dispensing liquid or deflecting droplets under an electric field (necessitating the droplets to be charged) in order to secure safe targeting. The aspirating principle is not applicable to liquid transport within this kind of dispensers.

Other features of the third aspect are as a rule as described for the first and second aspect.

Certain innovative aspects of the invention are defined in more detail in the appending claims. Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A flow through dispenser arrangement (102) for the drop-wise dispensation of liquid which arrangement comprises:
(a) a housing (104) comprising (i) a flow through microconduit (105) with an upstream end (106) and a downstream end (outlet) (107), and (ii) a dispenser orifice (108) between these two ends (106 and 107), and
(b) an inlet tube (110) which is attached to the upstream end (106) and provides an inlet (inlet end) (111) that can be connected to a liquid storage (112) for liquid (113) that is to be transported in flow through microconduit (105) and inlet tube (110) and/or dispensed through the orifice (108),
characterized in that the total inner volume (Vₜₒₜ) between said inlet (111) and said downstream end (107) and/or the total inner volume (V′ₜₒₜ) between said orifice (108) and said inlet are ≦10 μl.

2. The dispenser arrangement of claim 1, characterized in that
(a) Vₜₒₜ has a largest cross-sectional area (perpendicular to the flow direction) of ≦0.5 mm², and/or
(b) the inlet tube (110) has a length (in the flow direction) of ≧5 mm.

3. The dispenser arrangement of claim 1, characterized in that said inlet tube (110) comprises only one inlet for liquid to be passed through said flow through microconduit (105) and/or dispensed through said dispenser orifice (108).

4. The dispenser arrangement of claim 3, characterized in that the inner volume (V_{cond}) of said flow through microconduit (105) is ≦5 μl.

5. The dispenser arrangement of claim 3, characterized in that the ratio Vₜₒₜ/V_{cond} is ≦100 and/or the ratio Lₜₒₜ/L_{cond} is ≦100.

6. The dispenser arrangement of claim 1, characterized in that the inlet (111) and the dispenser orifice (108) are on different sides of the housing (104), preferably on opposite sides.

7. The dispenser arrangement of claim 1, characterized in that the outer rim of the dispenser orifice (108) is hydrophobic, possibly with this hydrophobicity extending to the outer surface area that surrounds the orifice.

8. The dispenser arrangement of claim 1, characterized in that the orifice (108) is capable of dispensation droplets each of which has a volume in the picolitre range (<5000 pl).

9. The dispenser arrangement of claim 1, characterized in that the flow through microconduit (105) comprises one, two or more dispenser orifices (108) that preferably open in the same side of the housing (104).

10. The dispenser arrangement of claim 1, characterized in that the housing (104) comprises
a) one, two or more of said flow through microconduit (105),
b) said inlet tube (110) for each of said flow through microconduits (105), and
c) pressure actuating means (109) that is capable of acting on each of said flow through microconduit (105),
wherein the dispenser orifice (108), the upstream end (106), the downstream end (107) and the inlet (111) preferably are oriented relative each other in the same way for each of said flow through microconduits (105).

11. The dispenser arrangement of claim 10, characterized in that there are two or more flow through microconduits (105) and that at least two of these have a common inlet.

12. An instrument set-up for the drop-wise dispensation of liquid to one, two or more target areas (200) which are present in the same side of a microdevice (201), characterized in comprising:
a) flow through drop dispenser arrangement (202) comprising: one or more flow through paths (220) which each has an outlet (221), an inlet (222), and a dispenser orifice (208) between the outlet (221) and the inlet (222), and a
b) generator for liquid transport (transport generator I) (217) that is capable of aspirating liquid or pushing liquid through said flow through paths (220) in the direction from the inlet (222) to the outlet(s) (221), said pushing being accomplished by applying over pressure gas to the liquid at the inlet(s) end (222).

13. The instrument set of claim 12, characterized in said liquid transport being by aspiration.

14. The instrument set-up of claim 12, characterized in further comprising:
a) a support (224) for retaining the microdevice (201),
b) a waste arrangement (215),
c) a liquid storage (212) comprising one, two or more reservoirs (214) for storing liquid (213) to be dispensed to the microdevice (201),
where
A) the outlet(s) (221) is fluidly connected with the waste arrangement (215),
B) the inlet(s) (222) is capable of being fluidly connected with one or more of the reservoirs (214) of the liquid storage (212),
C) the dispenser orifice(s) (208) and the side comprising the target areas (200) of a microdevice (201) retained on the support plate (219) are apposed to each other, and
D) either one or both of said microdevice (201), when retained on said support plate (224), and said dispenser orifice(s) (208) are movable relative to each other thereby enabling dispensation of liquid (203) to said one or more target areas (200) from a dispenser orifice (208).

15. The instrument set-up of claim 12, characterized in said dispenser arrangement being according to any of claims 1-11 where
the inlet (222) and the outlet (221) of each flow through path (220) are the inlet (111) and the downstream end (107), respectively, of the dispenser arrangement, and
said pressure actuating means (109) being associated with said walls via said housing (104).

16. The instrument set-up of claim 12, characterized in
a) said liquid storage (212) being a storage plate (223) comprising one, two or more liquid reservoirs (214) in one of its side,
b) said dispenser arrangement (202) being a transformation dispenser arrangement with two or more dispenser orifices (208), and two or more inlet tubes (210) each of which with an inlet (222), and
c) said microdevice (201) comprising two or more target areas (200), where
the side of the microdevice (201) comprising the target areas (200) is turned against the dispenser orifices (208), and
the side of the storage plate (223) containing the liquid reservoirs (214) is turned in the opposite direction as the side of the microdevice (201) comprising the target areas (200)), and
at least two of said target areas (200) define an array that has a geometric configuration that matches the geometric configuration of an array of at least two of said dispenser orifices (208), and
at least one, preferably at least two, of said one or more inlets (211) simultaneous fit into one or more of said reservoirs.

17. The instrument set-up of claim 12, characterized in said microdevice (201) being a microfluidic device comprising one, two or more microchannel structures (552) which each has an inlet port (550a,b) for liquid that defines one of said target areas (200).

18. The instrument set-up of claim 12, characterized in comprising a priming arrangement (216) for priming the inlet (222) of the dispensing arrangement (202) with a priming liquid, wherein priming of an inlet (222) means that priming liquid is permitted to fill a section next to the inlet (222) of the flow through path (220), with preference for said section encompassing at least the volume between said inlet (222) and the dispenser orifice (208) of said flow through path(s).

19. The instrument set-up of claim 18, characterized in the priming arrangement (216) being
(a) capable of being fluidly connected to the outlet(s) (221) of said flow through path(s) (220), and
(b) capable of introducing priming liquid via this/these outlet(s) (221) into the dispenser arrangement (202).

20. The instrument set-up of claim 18, characterized in the priming arrangement being
(a) capable of being fluidly connected to the inlet(s) (222), and
(b) capable of introducing priming liquid via this/these inlet(s) (222) into the dispenser arrangement (202).

21. The instrument set-up of claim 18, characterized in each inlet (222) being fluidly connected to a reservoir for priming liquid that during priming is pushed or aspirated through the inlet (222) from this reservoir.

22. The instrument set-up of claim 18, characterized in each outlet being fluidly connected to a reservoir (235) for priming liquid that during priming is pushed or aspirated through the outlet (221) to the inlet (222) from this reservoir (235).

23. The instrument set-up of claim 12, characterized in comprising a washing arrangement for washing the inlet(s) and flow through path(s).

24. The instrument set-up of claim 23, characterized in that said washing arrangement comprises a reservoir for washing liquid which reservoir is capable of being connected to the inlet(s).

25. The instrument set-up of claim 12, characterized in
(a) said microdevice (201) being a microfluidic device comprising one, two or more microchannel structures (552) which each is associated with one, two or more inlet ports (550a,b),
(b) each of said target areas (200) being one of said inlet ports (550a,b), and
(c) one or more of said inlet ports (550a,b) being in fluid communication, preferably directly, with a microcavity (554,555) that is capable of retaining a liquid volume in the μl-range (<5000 μl), such as in the nl-range (<5000 nl) or in the pl-range (<5000 pl).

26. The instrument set-up of claim 25, characterized in said microcavity being delineated in the downstream direction by a valve function, typically a non-closing valve, such as a passive or capillary valve.

27. The instrument set-up of claim 25, characterized in said microcavity being
a) a volume-metering microcavity, and/or
b) a part of a distribution manifold comprising two or more interlinked sub-microcavities which each has a volume-metering capability.
